(19) United States
(12) Patent Application Publication
(10) Pub. No.: US 2015/0293277 A1
(43) Pub. Date: Oct. 15, 2015

(54) DIFFRACTION-GRATING LENS, AND IMAGE-CAPTURING OPTICAL SYSTEM AND IMAGE-CAPTURING DEVICE USING SAID LENS

(71) Applicant: PANASONIC CORPORATION, Osaka (JP)

(72) Inventor: Takamasa Ando, Osaka (JP)

(21) Appl. No.: 14/439,992

(22) PCT Filed: Nov. 5, 2013
(86) PCT No.: PCT/JP2013/006520

§ 371 Date: Apr. 30, 2015

(30) Foreign Application Priority Data
Nov. 7, 2012 (JP) 2012-245486

(51) Int. Cl. G02B 5/18; H04N 5/225; G06F 17/50; G02B 13/18

(52) U.S. Cl. CPC G02B 5/1814; G02B 13/18; G02B 5/1847; H04N 5/2254; G06F 17/50

(57) ABSTRACT

A diffraction-grating lens has positive power and includes a lens base (11) on the surface of which a diffraction grating is formed, and an optical adjustment film (15) that is disposed on a diffraction grating surface of the lens base provided with the diffraction grating. The optical adjustment film is made of a material having a higher refractive index and lower wavelength dispersibility of the refractive index than those of a material of the lens base. When a reference position (17) is defined as a position (Rr) that is 70% of an effective radius (Re) measured from the center of the diffraction grating, the diffraction grating surface in the reference position is substantially parallel to a surface perpendicular to an optical axis (13). With this configuration, it is possible to provide a diffraction-grating lens and an image-capturing device that can reduce the generation of unnecessary diffraction light.

### TECHNICAL FIELD

The present invention relates to a diffraction-grating lens that condenses light by diffraction, and an image-capturing optical system and an image-capturing device that use the diffraction-grating lens.

### BACKGROUND ART

A diffraction optical element that includes a lens base provided with a diffraction grating and condenses or diverges light using a diffraction phenomenon is called a diffraction-grating lens (see, e.g., Patent Document 1). It is widely known that the diffraction-grating lens has an excellent capability to correct aberrations of a lens such as field curvature and chromatic aberration (i.e., a displacement of an imaging point due to wavelength). This is because the diffraction grating has dispersibility that is obtained by inverting the dispersion of an optical material (inverse dispersibility) or dispersibility that deviates from the linearity of the dispersion of an optical material (abnormal dispersibility). Therefore, the combination of the diffraction-grating lens and a general optical element can exhibit a significant ability to correct chromatic aberration.

Referring to FIGS. 5A to 5C, a shape of a conventional diffraction-grating lens will be described. The shape of the diffraction-grating lens is formed by a base shape and a shape of a diffraction grating. The base shape is a surface shape of a lens base provided with the diffraction grating. FIG. 5A shows a base shape Sb of the lens base. The base shape Sb is an aspherical shape. FIG. 5B shows a shape Sp1 of the diffraction grating. The shape Sp1 of the diffraction grating shown in FIG. 5B is determined by a phase function. The phase function is expressed by the following formula (2).

$$φ ( r ) = \frac{2 π}{{λ}_{0}} ψ ( r ) \\ ψ ( r ) = {a}_{1} r + {a}_{2} {r}^{2} + {a}_{3} {r}^{3} + {a}_{4} {r}^{4} + {a}_{5} {r}^{5} + {a}_{6} {r}^{6} + … + {a}_{i} {r}^{i} ( {r}^{2} = {x}^{2} + {y}^{2} ) \qquad ( 2 )$$

In the formula (2), φ(r) represents the phase function, ψ(r) represents an optical path difference function, r represents a distance from an optical axis in the radial direction, λ₀ represents a design wavelength, and a₁, a₂, a₃, a₄, a₅, a₆, . . . aᵢ are coefficients.

When the diffraction grating uses first-order diffracted light, as shown in FIG. 5B, a curve Sp of the phase function φ(r) is separated every time the phase from the reference point (i.e., the center) of the phase function φ(r) is 2nπ (n is a natural number of 1 or more), so that a phase difference function is obtained. This curve of the phase difference function, which has been separated at every 2nπ interval, indicates the shape Sp1 of the diffraction grating. Then, the shape Sp1 of the diffraction grating is added to the base shape Sb shown in FIG. 5A, resulting in a shape Sbp1 of a diffraction grating surface shown in FIG. 5C. The relationship of the formula (2) is used for the conversion from the phase difference function to the optical path difference function.

When the shape Sbp1 of the diffraction grating surface shown in FIG. 5C is formed on the actual lens base, a sufficient diffraction effect can be obtained if a height d of the diffraction steps satisfies the following formula (3).

d=mλ/(n1(λ)−1) (3)

where m represents a design order (m=1 for first-order diffraction light), λ represents a working wavelength, and n1(λ) represents a refractive index of a lens material of the lens base at the working wavelength λ. The refractive index of the lens material has wavelength dependence and is a function of wavelength. If a diffraction grating meets the formula (3), a phase difference of the phase function is 2π, which is a length from the bottom to the top of a ring-shaped diffraction zone (i.e., a surface between the diffraction steps). Therefore, the optical path difference for light of the working wavelength λ is an integral multiple of the wavelength. Consequently, the diffraction efficiency of first-order diffraction light for light of the working wavelength λ can be substantially 100%. According to the formula (3), the value d for achieving 100% diffraction efficiency varies with the wavelength λ. If the value d is fixed, the diffraction efficiency will not be 100% at a wavelength other than the wavelength λ that satisfies the formula (3).

A diffraction-grating lens used for general imaging applications is required to diffract light in a wide wavelength range (e.g., a visible light range of about 400 nm to 700 nm). Therefore, when visible light enters the diffraction-grating lens including the lens base provided with the diffraction grating, unnecessary-order diffraction light is generated in addition to first-order diffraction light for light of the working wavelength λ. Such unnecessary-order diffraction light causes a flare or a ghost in an image, and thus degrades the image quality.

To deal with this issue, as shown in FIG. 6A, a diffraction-grating lens 101a including a lens base 102a, a diffraction grating 103a, and an optical adjustment film 104a has been proposed (see, e.g., Patent Document 2). In the diffraction-grating lens 101a, the diffraction grating 103a is formed on the lens base 102a, and the optical adjustment film 104a is disposed on a diffraction grating surface of the lens base 102a.

Due to the presence of the optical adjustment film 104a, the formula (3) for the height d of the diffraction steps is modified as follows.

d=mλ/(n1(λ)−n2(λ)) (4)

where n2(λ) represents a refractive index of the optical adjustment film 104a covering the diffraction grating surface at the working wavelength λ.

If the value d of the formula (4) is constant for each of the wavelengths λ, in the visible light range, it is possible to reduce the wavelength dependence of the height d of the diffraction steps of the diffraction grating. This can reduce unnecessary-order diffraction light, and thus can suppress a flare.

Therefore, the lens base 102a with a refractive index n1(λ) may be combined with the optical adjustment film 104a with a refractive index n2(λ) to show the wavelength dependence such that the value d is constant for each of the wavelengths λ, in the visible light range. In general, a material having a high refractive index and low wavelength dispersibility is combined with a material having a low refractive index and high wavelength dispersibility. For example, the materials may be selected so that the refractive index of the optical adjustment film 104a is lower than that of the lens base 102a, and the wavelength dispersibility of the refractive index of the optical adjustment film 104a is higher than that of the refractive index of the lens base 102a in the wavelength range of the light used.

FIG. 6B is a cross-sectional view showing a configuration of a diffraction-grating lens 101b in which the refractive index n2(λ) is larger than the refractive index n1(λ). An optical adjustment film 104b is made of a material having a higher refractive index and lower wavelength dispersibility of the refractive index than those of a material of a lens base 102b. Since the refractive index n2(λ) is higher than the refractive index n1(λ), the denominator of the formula (4) is negative, and the height d of the diffraction steps is negative. In this case, the diffraction grating surface has a shape that is obtained by adding the inverted phase of the phase difference function (FIG. 5B) to the base shape. Therefore, the diffraction steps are formed in the direction in which the amount of aspheric sag is increased.

Even in that case, like the diffraction-grating lens 101a, the diffraction-grating lens 101b also can reduce the wavelength dependence of the height d of the diffraction steps of the diffraction grating. This can reduce unnecessary-order diffraction light, and thus can suppress a flare caused by the unnecessary-order diffraction light.

### PRIOR ART DOCUMENTS

### Patent Documents

Patent Document 1: WO 2011/052188 A1

Patent Document 2: JP H9(1997)-127321 A

### DISCLOSURE OF INVENTION

### Problem to be Solved by the Invention

However, the diffraction-grating lens shown in FIG. 6B has the following problems.

FIG. 7 is an enlarged view showing the main portion in FIG. 6B. In a lens used for an image-capturing device, it is necessary to consider light that enters the lens at a wide angle of view, i.e., at a large angle with respect to the optical axis. Referring to FIG. 7, an upper light beam 111 and a lower light beam 112 are considered. The upper light beam 111 and the lower light beam 112 enter the peripheral portions of the diffraction-grating lens 101b, which are away from the optical axis 113, at wide angles of view from the underside, respectively. The incident upper and lower light beams 111, 112 pass through the positions on the opposite sides of a diffraction zone 105 in the radial direction.

An optical path difference L11 corresponds to a difference in optical path between the upper light beam 111 passing through the bottom of a diffraction step and the upper light beam 111 passing through the top of the diffraction step. An optical path difference L12 corresponds to a difference in optical path between the lower light beam 112 passing through the bottom of the diffraction step and the lower light beam 112 passing through the top of the diffraction step. As can be seen from FIG. 7, the distance L11 is significantly different from the distance L12.

As described above, when light enters the diffraction-grating lens 101b at a wide angle of view, the optical path difference in the diffraction step portion differs significantly between the positions on the opposite sides of the diffraction step in the radial direction. It is desirable that the height d of the diffraction steps is adjusted to oblique incidence. In this case, if the height d of the diffraction steps is reduced to make the optical path difference L11 smaller, the optical path difference L12 becomes even smaller because it is originally small. Thus, there is a contradiction between the upper light beam and the lower light beam in terms of the effect of adjusting the height d of the diffraction steps. Consequently, a considerable amount of unnecessary diffraction light is generated, and a flare is caused that degrades the image quality.

To solve the above problems, it is an object of the present invention to provide a diffraction-grating lens and an image-capturing device that can reduce the generation of unnecessary diffraction light.

### Means for Solving Problem

A first diffraction-grating lens of the present invention has positive power and includes a lens base on a surface of which a diffraction grating is formed, and an optical adjustment film that is disposed on a diffraction grating surface of the lens base provided with the diffraction grating. To solve the above problems, the optical adjustment film is made of a material having a higher refractive index and lower wavelength dispersibility of the refractive index than those of a material of the lens base. Moreover, when a reference position is defined as a position that is 70% of an effective radius measured from a center of the diffraction grating, the diffraction grating surface in the reference position is substantially parallel to a surface perpendicular to an optical axis.

A second diffraction-grating lens of the present invention has positive power and includes a lens base on a surface of which a diffraction grating is formed, and an optical adjustment film that is disposed on a diffraction grating surface of the lens base provided with the diffraction grating. To solve the above problems, the optical adjustment film is made of a material having a higher refractive index and lower wavelength dispersibility of the refractive index than those of a material of the lens base. Moreover, when a reference position is defined as a position that is 70% of an effective radius measured from a center of the diffraction grating, an amount s of aspheric sag in a diffraction step position that is located on an optical axis side of the reference position and also is closest to the reference position is substantially equal to a product of a height d of diffraction steps of the diffraction grating and a number k of diffraction steps in a region between the center and the reference position.

A first image-capturing optical system of the present invention includes a diffraction-grating lens and a diaphragm. The diffraction-grating lens has positive power and includes a lens base on a surface of which a diffraction grating is formed, and an optical adjustment film that is disposed on a diffraction grating surface of the lens base provided with the diffraction grating. To solve the above problems, the diffraction grating surface on which the diffraction grating is formed in the diffraction-grating lens is a lens surface that is closest to the diaphragm. Moreover, the optical adjustment film is made of a material having a higher refractive index and lower wavelength dispersibility of the refractive index than those of a material of the lens base. Further, an effective radius is defined by the diaphragm for the diffraction grating, and when a reference position is defined as a position that is 70% of the effective radius measured from a center of the diffraction grating, the diffraction grating surface in the reference position is substantially parallel to a surface perpendicular to an optical axis.

A second image-capturing optical system of the present invention includes a diffraction-grating lens and a diaphragm. The diffraction-grating lens has positive power and includes a lens base on a surface of which a diffraction grating is formed, and an optical adjustment film that is disposed on a diffraction grating surface of the lens base provided with the diffraction grating. To solve the above problems, the diffraction grating surface on which the diffraction grating is formed in the diffraction-grating lens is a lens surface that is closest to the diaphragm. Moreover, the optical adjustment film is made of a material having a higher refractive index and lower wavelength dispersibility of the refractive index than those of a material of the lens base. Further, an effective radius is defined by the diaphragm for the diffraction grating, and when a reference position is defined as a position that is 70% of the effective radius measured from a center of the diffraction grating, an amount s of aspheric sag in a diffraction step position that is located on an optical axis side of the reference position and also is closest to the reference position is substantially equal to a product of a height d of diffraction steps of the diffraction grating and a number k of diffraction steps in a region between the center and the reference position.

A method for designing a diffraction-grating lens of the present invention includes designing a diffraction-grating lens that includes a lens base provided with a diffraction grating. To solve the above problems, the diffraction-grating lens is designed so that when a reference position is defined as a position that is 70% of an effective radius measured from a center of the diffraction grating, an amount s of aspheric sag in a diffraction step position that is located on an optical axis side of the reference position and also is closest to the reference position is substantially equal to a product of a height d of diffraction steps of the diffraction grating and a number k of diffraction steps in a region between the center and the reference position.

An image-capturing device of the present invention includes the diffraction-grating lens and an image-capturing element that receives a subject image formed by the diffraction-grating lens and converts the subject image into an electrical signal.

### Effects of the Invention

According to the present invention, the surface of the diffraction grating is made substantially parallel to the surface perpendicular to the optical axis of the lens. Thus, the present invention can provide a diffraction-grating lens and an image-capturing device that can reduce the generation of unnecessary diffraction light.

### BRIEF DESCRIPTION OF DRAWINGS

FIG. 1 is a cross-sectional view schematically showing an optical system of an image-capturing device in Embodiment 1 of the present invention.

FIG. 2 is a cross-sectional view showing the main portion of the optical system.

FIG. 2(a) is an enlarged view of a third lens. FIG. 2(b) is an enlarged view showing a cross-sectional shape of a surface of the third lens on an image surface side.

FIG. 3 is a cross-sectional view showing a shape of a diffraction grating surface in Embodiment 1 of the present invention.

FIG. 4 is a cross-sectional view showing a shape of a diffraction-grating lens in Embodiment 2 of the present invention.

FIG. 5A is a graph showing a base shape of a lens base of a conventional diffraction-grating lens.

FIG. 5B is a graph showing a shape of a diffraction grating of a conventional diffraction-grating lens.

FIG. 5C is a graph showing a shape of a diffraction grating surface of a conventional diffraction-grating lens.

FIG. 6A is a cross-sectional view showing a shape of a conventional diffraction-grating lens.

FIG. 6B is a cross-sectional view showing a shape of a conventional diffraction-grating lens.

FIG. 7 is an enlarged cross-sectional view showing a shape of the main portion of the conventional diffraction-grating lens.

### DESCRIPTION OF THE INVENTION

In the first diffraction-grating lens and the first image-capturing optical system of the present invention, the angle of inclination of the diffraction grating surface in the reference position with respect to the surface perpendicular to the optical axis may be 13 degrees or less. Preferably, the angle of inclination may be 10 degrees or less.

In the second diffraction-grating lens, the second image-capturing optical system, and the method for designing a diffraction-grating lens of the present invention, the amount s of aspheric sag in the diffraction step position that is located on the optical axis side of the reference position and also is closest to the reference position may be 50% to 150% of the product of the height d of diffraction steps of the diffraction grating and the number k of diffraction steps in the region between the center and the reference position. Preferably, the amount s of aspheric sag may be 65% to 135% of the product of the height d of diffraction steps of the diffraction grating and the number k of diffraction steps in the region between the center and the reference position.

Hereinafter, preferred embodiments of the present invention will be described with reference to the drawings.

### Embodiment 1

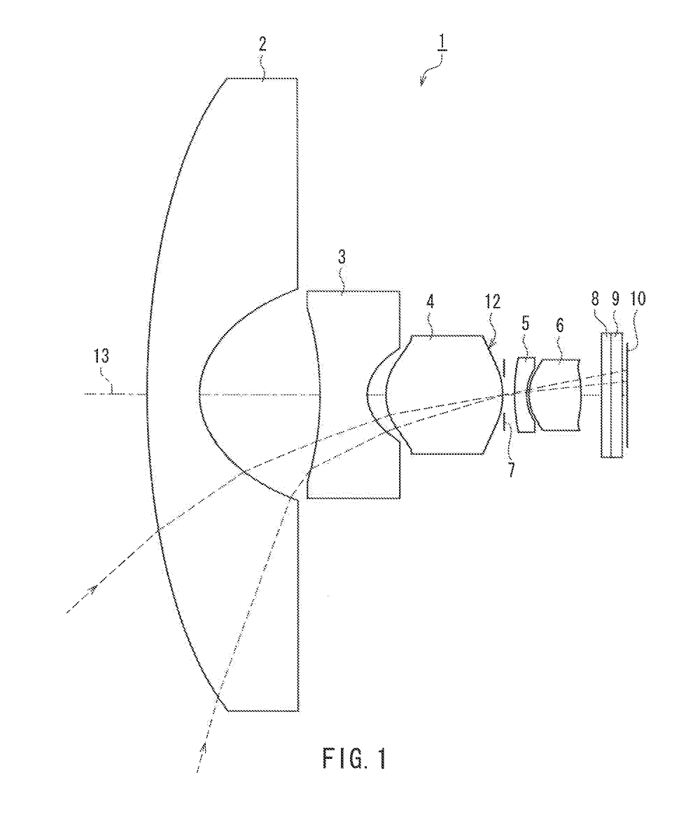

FIG. 1 is a cross-sectional view schematically showing an optical system of an image-capturing device 1 in Embodiment 1 of the present invention. The image-capturing device 1 includes an optical system in which first to fifth lenses 2 to 6 are arranged in this order from the object side (i.e., the left side of FIG. 1). The first lens 2 is a meniscus lens with a concave surface on the image surface side. The second lens 3 is a double-concave lens. The third lens 4 is a diffraction-grating lens having positive power. The third lens 4 includes a lens base 11, and a diffraction grating is formed on the surface 12 of the lens base 11, which is on the image surface side (i.e., the right side of FIG. 1). The fourth lens 5 is a meniscus lens with a convex surface on the object side. A diaphragm 7 is provided between the third lens 4 and the fourth lens 5. The fifth lens 6 is a convex lens. An IR cutoff filter 8 and a cover glass 9 are arranged on the image surface side of the fifth lens 6. An image-capturing element 10 is arranged in a position where an image surface is to be formed. The image-capturing element 10 receives a subject image and converts it into an electrical signal. Then, the electrical signal is converted into image data by a processing unit (not shown), and the image data is stored in a memory. The cover glass 9 protects the surface of the image-capturing element 10.

In FIG. 1, the broken lines indicate optical paths of incident light on the image-capturing device 1. The light entering from the object side passes through the first to fifth lenses 2 to 6 and reaches the image-capturing element 10. The light that has entered at a wide angle of view is refracted by the first lens 2 and the second lens 3. Therefore, the angle of the refracted light with respect to an optical axis 13 becomes small. Nevertheless, the refracted light still enters the third lens 4 at a considerably large angle.

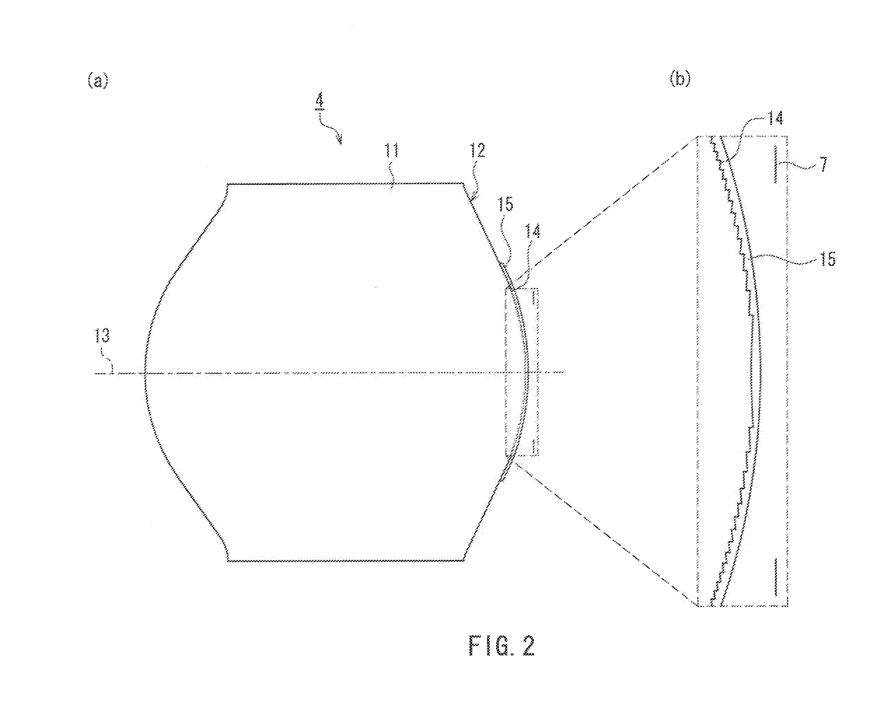

FIG. 2(a) is an enlarged view of the third lens 4. FIG. 2(b) is an enlarged view showing a cross-sectional shape of the surface 12 of the lens base 11 of the third lens 4, which is on the image surface side. A diffraction grating 14 is formed on the surface 12, and an optical adjustment film 15 is disposed on the diffraction grating 14.

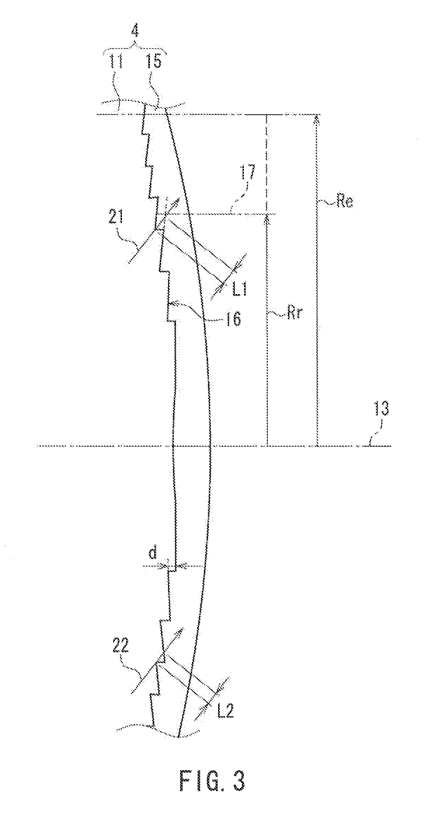

The features of the diffraction-grating lens in this embodiment will be described with reference to FIG. 3. FIG. 3 is a cross-sectional view showing a shape of a diffraction grating surface of the third lens 4 in this embodiment. The lens base 11 is made of a material having a low refractive index and high wavelength dispersibility of the refractive index. The optical adjustment film 15 is made of a material having a high refractive index and low wavelength dispersibility of the refractive index. In the present specification, the levels (high or low) of the refractive index and the wavelength dispersibility of the refractive index mean the relative relationship between them.

The surface 12 of the third lens 4 has a shape that is determined by a base shape and a phase difference function. Specifically, the shape of the surface 12 is formed in the following manner. As shown in FIG. 3, a reference position 17 is defined as a position Rr that is 70% of an effective radius Re of the diffraction-grating lens measured from the center (i.e., the optical axis 13). The shape of the surface 12 is formed so that the diffraction grating surface in the reference position 17 is substantially parallel to a surface perpendicular to the optical axis 13. By forming the diffraction grating surface as described above, the inclination of the diffraction grating surface with respect to the surface perpendicular to the optical axis can be within the tolerance in all diffraction zones within the range of the effective radius of the diffraction-grating lens. The effective radius of the lens is a radius of the region defined by the diaphragm 7.

The effect of the shape of the diffraction grating 14 of the third lens 4 will be described below. An upper light beam 21 and a lower light beam 22 enter the peripheral portions of the diffraction-grating lens, which are away from the optical axis 13, at wide angles of view from the underside, respectively. The incident upper and lower light beams 21, 22 pass through the positions on the opposite sides of a diffraction zone 16 in the radial direction. The upper light beam 21 passes through the diffraction zone 16 located on the upper side of the optical axis 13. The lower light beam 22 passes through the diffraction zone 16 located on the lower side of the optical axis 13.

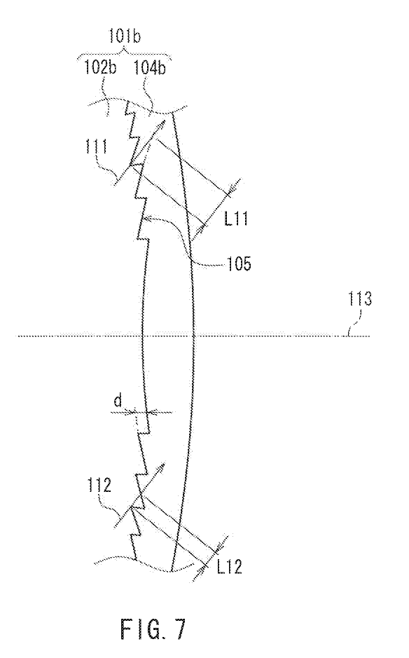

An optical path difference L1 corresponds to a difference in optical path between the upper light beam 21 passing through the bottom of a diffraction step and the upper light beam 21 passing through the top of the diffraction step. An optical path difference L2 corresponds to a difference in optical path between the lower light beam 22 passing through the bottom of the diffraction step and the lower light beam 22 passing through the top of the diffraction step. Since the inclination of each of the diffraction zones 16 with respect to the surface perpendicular to the optical axis 13 is small, the optical path difference L1 and the optical path difference L2 are approximately the same. Thus, the difference between L1 and L2 can be sufficiently smaller than the difference between L11 and L12 shown in FIG. 7. Consequently, the adjustment of the height of diffraction steps produces the same effect for both the optical path differences L11 and L12, so that the generation of unnecessary diffraction light can be reduced.

In view of the range in which the above effect can be obtained sufficiently for practical use, the diffraction grating surface that is “substantially parallel to the surface perpendicular to the optical axis” means that the diffraction grating surface may be inclined at 13 degrees or less with respect to the surface perpendicular to the optical axis. Within this range, the generation of unnecessary diffraction light can be reduced. The diffraction grating surface may be inclined in any direction with respect to the surface perpendicular to the optical axis as long as the angle of inclination with respect to the surface perpendicular to the optical axis is 13 degrees or less. If the angle of inclination with respect to the surface perpendicular to the optical axis is 10 degrees or less, the generation of unnecessary diffraction light can be reduced further.

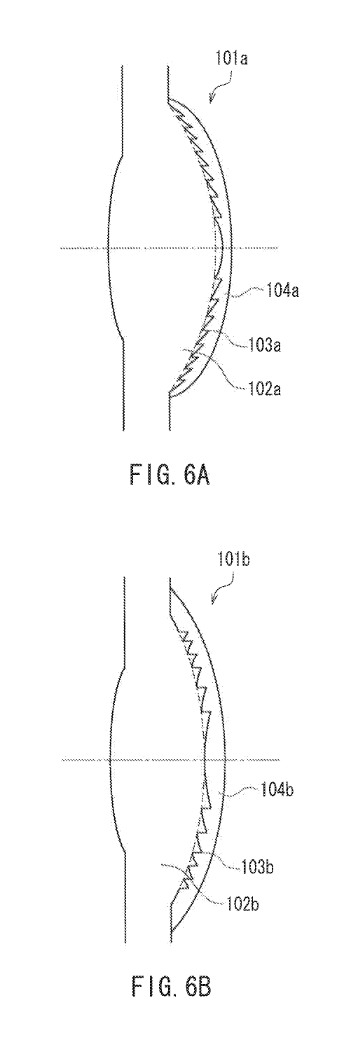

The diffraction grating surface in the position that is 70% of the effective radius of the diffraction-grating lens measured from the center can be made substantially parallel to the surface perpendicular to the optical axis, e.g., by increasing a curvature of the base shape compared to the conventional diffraction-grating lens shown in FIG. 6B.

As described above, in the diffraction-grating lens (the third lens 4) of the image-capturing device of this embodiment, the diffraction grating surface in the position that is 70% of the effective radius of the diffraction-grating lens measured from the center is made substantially parallel to the surface perpendicular to the optical axis. Thus, even if light enters the diffraction-grating lens at a large incident angle with respect to the optical axis, the generation of unnecessary diffraction light can be reduced. This can suppress the occurrence of a flare and improve the image quality.

In this embodiment, the diaphragm 7 is provided. However, the present invention does not necessarily require the diaphragm 7. If the diaphragm 7 is not used, the effective radius of the third lens 4 may be a radius of the effective region, except for the koba portion (round edge portion), of the lens.

### Embodiment 2

A diffraction-grating lens in Embodiment 2 of the present invention is characterized in that a shape of a diffraction grating surface is formed in a different method from the third lens 4 in Embodiment 1. The configuration of an image-capturing device in this embodiment is the same as that of the image-capturing device 1 in Embodiment 1 except for the method for forming a shape of a diffraction grating surface. In this embodiment, the same components as those of Embodiment 1 are denoted by the same reference numerals, and the explanation will not be repeated.

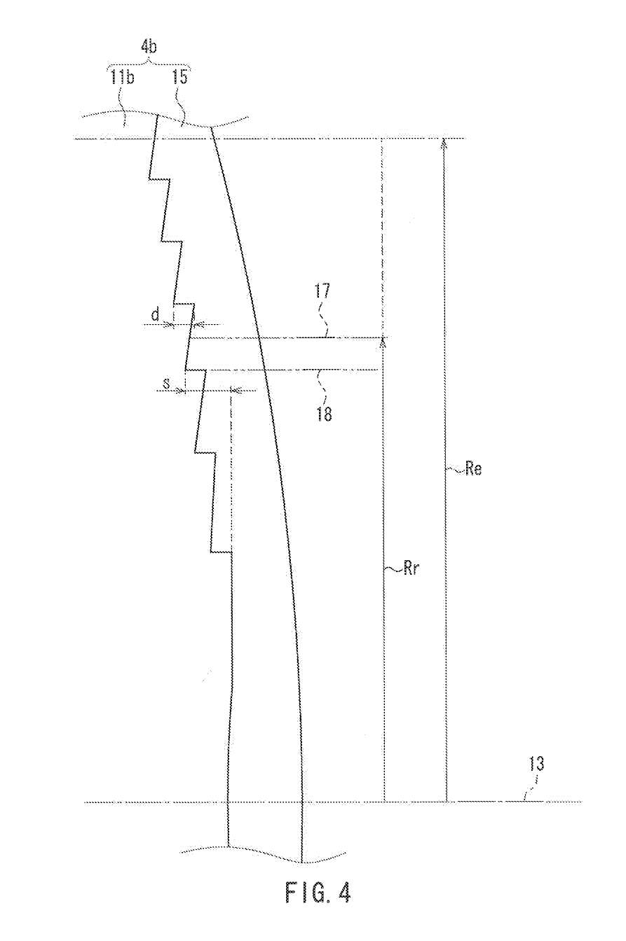

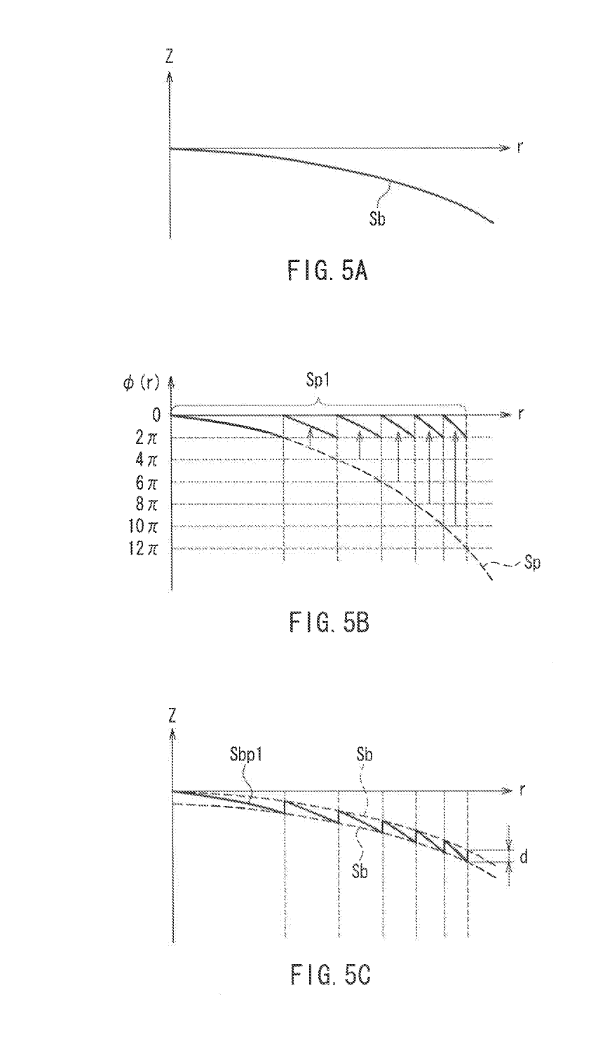

FIG. 4 is a cross-sectional view showing a shape of a diffraction grating surface of a diffraction-grating lens 4b as a third lens. The shape of the diffraction grating surface is determined by setting the amount of aspheric sag using a particular method of this embodiment. As shown in FIG. 4, a reference position 17 is defined as a position Rr that is 70% of an effective radius Re of the diffraction-grating lens 4b measured from the center of the diffraction-grating lens 4b. The shape of the diffraction grating surface is formed so that the amount s of aspheric sag in a diffraction step position 18 that is located on the optical axis side of the reference position 17 and also is closest to the reference position 17 is substantially equal to the product of the height d of diffraction steps of the diffraction grating and the number k of diffraction steps in a region between the center and the reference position 17. Thus, s, d and k satisfy the following formula (1).

s=d×k (1)

By satisfying the formula (1), the diffraction grating surface in the reference position 17 is substantially parallel to a surface perpendicular to the optical axis. Moreover, the inclination of the diffraction grating surface with respect to the surface perpendicular to the optical axis can be within tolerance in any position of the diffraction-grating lens 4b.

Therefore, similarly to Embodiment 1, the diffraction-grating lens 4b of the image-capturing device of this embodiment has the diffraction grating surface perpendicular to the optical axis, so that the generation of unnecessary diffraction light can be reduced. This can suppress the occurrence of a flare and improve the image quality.

When the amount s of aspheric sag in the diffraction step position 18 that is located on the optical axis side of the reference position 17 and also is closest to the reference position 17 is substantially equal to the product of the height d of diffraction steps of the diffraction grating and the number k of diffraction steps in the region between the center and the reference position 17, the amount s of aspheric sag either may be exactly equal to the product, or may vary within a tolerance in view of the range in which the above effect can be obtained sufficiently for practical use. Specifically, the amount s of aspheric sag in the diffraction step position 18 may be 50% to 150% of the product of the height d of diffraction steps of the diffraction grating and the number k of diffraction steps in the region between the center and the reference position 17. If the amount s of aspheric sag in the diffraction step position 18 is 65% to 135% of the product, the occurrence of a flare can be suppressed further, and thus the image quality can be improved.

In this embodiment, the image-capturing device includes five lenses. However, even if the number of lenses is different, the present invention can be applied to any image-capturing device as long as the diffraction-grating lens is used as a third lens.

### INDUSTRIAL APPLICABILITY

The diffraction-grating lens of the present invention has the effect of suppressing the occurrence of a flare, and is applicable to an image-capturing device or the like.

### DESCRIPTION OF REFERENCE NUMERALS

1 Image-capturing device
2 First lens
3 Second lens
4 Third lens
4b Diffraction-grating lens
5 Forth lens
6 Fifth lens
7 Diaphragm
8 IR cutoff filter
9 Cover glass
10 Image-capturing element
11, 11b Lens base
12 Surface on image surface side
13 Optical axis
14 Diffraction grating
15 Optical adjustment film
16 Diffraction zone
17 Reference position
18 Diffraction step position
21 Upper light beam
22 Lower light beam

1. A diffraction-grating lens having positive power and comprising:
a lens base on a surface of which a diffraction grating is formed; and
an optical adjustment film that is disposed on a diffraction grating surface of the lens base provided with the diffraction grating,
wherein the optical adjustment film is made of a material having a higher refractive index and lower wavelength dispersibility of the refractive index than those of a material of the lens base, and
wherein when a reference position is defined as a position that is 70% of an effective radius measured from a center of the diffraction grating, the diffraction grating surface in the reference position is substantially parallel to a surface perpendicular to an optical axis.

2. The diffraction-grating lens according to claim 1, wherein an angle of inclination of the diffraction grating surface in the reference position with respect to the surface perpendicular to the optical axis is 13 degrees or less.

3. The diffraction-grating lens according to claim 1, wherein an angle of inclination of the diffraction grating surface in the reference position with respect to the surface perpendicular to the optical axis is 10 degrees or less.

4. A diffraction-grating lens having positive power and comprising:
a lens base on a surface of which a diffraction grating is formed; and
an optical adjustment film that is disposed on a diffraction grating surface of the lens base provided with the diffraction grating,
wherein the optical adjustment film is made of a material having a higher refractive index and lower wavelength dispersibility of the refractive index than those of a material of the lens base, and
wherein when a reference position is defined as a position that is 70% of an effective radius measured from a center of the diffraction grating, an amount s of aspheric sag in a diffraction step position that is located on an optical axis side of the reference position and also is closest to the reference position is substantially equal to a product of a height d of diffraction steps of the diffraction grating and a number k of diffraction steps in a region between the center and the reference position.

5. The diffraction-grating lens according to claim 4, wherein the amount s of aspheric sag in the diffraction step position that is located on the optical axis side of the reference position and also is closest to the reference position is 50% to 150% of the product of the height d of diffraction steps of the diffraction grating and the number k of diffraction steps in the region between the center and the reference position.

6. The diffraction-grating lens according to claim 4, wherein the amount s of aspheric sag in the diffraction step position that is located on the optical axis side of the reference position and also is closest to the reference position is 65% to 135% of the product of the height d of diffraction steps of the diffraction grating and the number k of diffraction steps in the region between the center and the reference position.

7. An image-capturing optical system comprising a diffraction-grating lens and a diaphragm,
the diffraction-grating lens having positive power and comprising:
a lens base on a surface of which a diffraction grating is formed; and
an optical adjustment film that is disposed on a diffraction grating surface of the lens base provided with the diffraction grating,
wherein the diffraction grating surface on which the diffraction grating is formed in the diffraction-grating lens is a lens surface that is closest to the diaphragm,
wherein the optical adjustment film is made of a material having a higher refractive index and lower wavelength dispersibility of the refractive index than those of a material of the lens base,
and
wherein an effective radius is defined by the diaphragm for the diffraction grating, and when a reference position is defined as a position that is 70% of the effective radius measured from a center of the diffraction grating, the diffraction grating surface in the reference position is substantially parallel to a surface perpendicular to an optical axis.

8. The image-capturing optical system according to claim 7, wherein an angle of inclination of the diffraction grating surface in the reference position with respect to the surface perpendicular to the optical axis is 13 degrees or less.

9. The image-capturing optical system according to claim 7, wherein an angle of inclination of the diffraction grating surface in the reference position with respect to the surface perpendicular to the optical axis is 10 degrees or less.

10. An image-capturing optical system comprising a diffraction-grating lens and a diaphragm,
the diffraction-grating lens having positive power and comprising:
a lens base on a surface of which a diffraction grating is formed; and
an optical adjustment film that is disposed on a diffraction grating surface of the lens base provided with the diffraction grating,
wherein the diffraction grating surface on which the diffraction grating is formed in the diffraction-grating lens is a lens surface that is closest to the diaphragm, wherein the optical adjustment film is made of a material having a higher refractive index and lower wavelength dispersibility of the refractive index than those of a material of the lens base, and
wherein an effective radius is defined by the diaphragm for the diffraction grating, and when a reference position is defined as a position that is 70% of the effective radius measured from a center of the diffraction grating, an amount s of aspheric sag in a diffraction step position that is located on an optical axis side of the reference position and also is closest to the reference position is substantially equal to a product of a height d of diffraction steps of the diffraction grating and a number k of diffraction steps in a region between the center and the reference position.

11. The image-capturing optical system according to claim 10, wherein the amount s of aspheric sag in the diffraction step position that is located on the optical axis side of the reference position and also is closest to the reference position is 50% to 150% of the product of the height d of diffraction steps of the diffraction grating and the number k of diffraction steps in the region between the center and the reference position.

12. The image-capturing optical system according to claim 10, wherein the amount s of aspheric sag in the diffraction step position that is located on the optical axis side of the reference position and also is closest to the reference position is 65% to 135% of the product of the height d of diffraction steps of the diffraction grating and the number k of diffraction steps in the region between the center and the reference position.

13. A method for designing a diffraction-grating lens comprising a lens base provided with a diffraction grating,
the method comprising:
designing a diffraction-grating lens so that when a reference position is defined as a position that is 70% of an effective radius measured from a center of the diffraction grating, an amount s of aspheric sag in a diffraction step position that is located on an optical axis side of the reference position and also is closest to the reference position is substantially equal to a product of a height d of diffraction steps of the diffraction grating and a number k of diffraction steps in a region between the center and the reference position.

14. The method for designing a diffraction-grating lens according to claim 13, wherein the amount s of aspheric sag in the diffraction step position that is located on the optical axis side of the reference position and also is closest to the reference position is set to 50% to 150% of the product of the height d of diffraction steps of the diffraction grating and the number k of diffraction steps in the region between the center and the reference position.

15. The method for designing a diffraction-grating lens according to claim 13, wherein the amount s of aspheric sag in the diffraction step position that is located on the optical axis side of the reference position and also is closest to the reference position is set to 65% to 135% of the product of the height d of diffraction steps of the diffraction grating and the number k of diffraction steps in the region between the center and the reference position.

16. An image-capturing device comprising:
the diffraction-grating lens according to claim 1; and
an image-capturing element that receives a subject image formed by the diffraction-grating lens and converts the subject image into an electrical signal.
